(19) United States
(12) Patent Application Publication
(10) Pub. No.: US 2023/0230417 A1
(43) Pub. Date: Jul. 20, 2023

(54) LEARNING ASSISTANCE DEVICE AND LEARNING ASSISTANCE SYSTEM

(71) Applicant: Panasonic Intellectual Property Management Co. Ltd., Osaka (JP)

(72) Inventors: Katsuhiro KANAMORI, Nara (JP); Mototaka YOSHIOKA, Osaka (JP); Yoshinori MATSUI, Nara (JP)

(21) Appl. No.: 17/914,241

(22) PCT Filed: Mar. 19, 2021
(86) PCT No.: PCT/JP2021/011467

§ 371 Date: Sep. 23, 2022

(30) Foreign Application Priority Data
Apr. 2, 2020 (JP) 2020-066588

(51) Int. Cl. G06V 40/20; G09B 5/06; G06V 40/16

(52) U.S. Cl. CPC G06V 40/20; G09B 5/065; G06V 40/176

(57) ABSTRACT

A learning assistance device for a user to perform a learning task includes: a first concentration level estimator that estimates a first concentration level of the user, by analyzing information from an image capturing section that captures an image of a user; a second concentration level estimator that estimates a second concentration level of the user, by analyzing information which the user has actively input when performing a learning task; and a presentation switching section that switches between learning task content and between presentation schemes, based on at least one of the first concentration level or the second concentration level.

### CROSS-REFERENCE OF RELATED APPLICATIONS

This application is the U.S. National Phase under 35 U.S.C. § 371 of International Patent Application No. PCT/JP2021/011467, filed on Mar. 19, 2021, which in turn claims the benefit of Japanese Patent Application No. 2020-066588, filed on Apr. 2, 2020, the entire disclosures of which applications are incorporated by reference herein.

### TECHNICAL FIELD

The present invention relates to a learning assistance device and a learning assistance system.

### BACKGROUND ART

Devices that measure a concentration level of a user when the user performs a task have been devised. Patent Literature (PTL) 1 discloses a video reproduction device, etc. that measure a concentration level of a user on tasks that the user actively performs, such as email writing and web browsing, and on tasks that the user passively performs, such as video viewing, and reproduce a video according to the concentration level that has been measured.

### CITATION LIST

### Patent Literature

[PTL 1] International Publication No. 2007/132566

### SUMMARY OF INVENTION

### Technical Problem

However, the video reproduction device, etc. disclosed by PTL 1 is not capable of appropriately switching between a task that the user actively performs and a task that the user passively performs.

In view of the above, the present invention provides a learning assistance device capable of appropriately switching between a task that a user actively performs and a task that a user passively performs, according to a concentration level of the user.

### Solution to Problem

A learning assistance device according to one aspect of the present invention is a learning assistance device for a user to perform a learning task. The learning assistance device includes: a first concentration level estimator that estimates a first concentration level of the user, by analyzing information from an image capturing section that captures an image of a user; a second concentration level estimator that estimates a second concentration level of the user, by analyzing information which the user has actively input when performing a learning task; and a presentation switching section that switches between learning task content and between presentation schemes, based on at least one of the first concentration level or the second concentration level.

A learning assistance system according to one aspect of the present invention is a learning assistance system for a user to perform a learning task. The learning assistance system includes: a display; an image capturing section that captures an image of a user; a first concentration level estimator that estimates a first concentration level of user 1, by analyzing information from the image capturing section; a second concentration level estimator that estimates a second concentration level of user 1, by analyzing information which user 1 has actively input when performing the learning task; and a presentation switching section that switches between learning task content and between presentation schemes, based on at least one of the first concentration level or the second concentration level.

### Advantageous Effects of Invention

The learning assistance device, etc. according to one aspect of the present invention are capable of appropriately switching between a task that a user actively performs and a task that a user passively performs, according to a concentration level of the user.

### BRIEF DESCRIPTION OF DRAWINGS

FIG. 1 is a block diagram illustrating a learning assistance device according to an embodiment.

FIG. 2 is a flowchart illustrating the processing of the learning assistance device according to the embodiment.

FIG. 3A is a diagram illustrating a situation in which a user is performing an active task.

FIG. 3B is a diagram illustrating a situation in which the user is performing a passive task.

FIG. 4A is a diagram illustrating a situation in which a concentration level of the user during performing an active task is measured.

FIG. 4B is a diagram illustrating a situation in which a concentration level of the user during performing a passive task is measured.

FIG. 5 is a flowchart illustrating the processing of determining a first concentration level performed by the learning assistance device according to the embodiment.

FIG. 6 is a diagram illustrating an example of the habit of a subject that is used by the learning assistance device according to the embodiment in the determination of the first concentration level.

FIG. 7 is a diagram illustrating a time slot of the comparison between the first concentration level and the second concentration level performed by the concentration level determiner according to the embodiment.

FIG. 8 is a diagram illustrating an overview of the measurement of the first concentration level in the learning assistance device according to the embodiment.

FIG. 9 is a diagram illustrating an overview of the measurement of the second concentration level in the learning assistance device according to the embodiment.

FIG. 10 is a diagram illustrating the switching of the active task and the passive task in the learning assistance device according to the embodiment.

FIG. 11 is a table illustrating the details of the switching of the active task and the passive task in the learning assistance device according to the embodiment.

FIG. 12 is a flowchart illustrating an example of the processing performed by the learning assistance device according to the embodiment.

FIG. 13 is a flowchart illustrating another example of the processing performed by the learning assistance device according to the embodiment.

FIG. 14 is a diagram illustrating an example of determination of the state of the user performed by comparing the first concentration level and the second concentration level in the learning assistance device according to the embodiment.

FIG. 15 is a diagram illustrating guiding of the state of the user performed by comparing the first concentration level and the second concentration level in the learning assistance device according to the embodiment.

### DESCRIPTION OF EMBODIMENTS

Hereinafter, embodiments of the present invention will be described with reference to the Drawings. It should be noted that the embodiments described below each show a general or specific example. The numerical values, shapes, materials, structural components, the arrangement and connection of the structural components, etc. shown in the following exemplary embodiments are mere examples, and therefore do not limit the scope of the present invention. Among the structural components in the embodiments described below, those not recited in the independent claims will be described as optional structural components.

In addition, each diagram is a schematic diagram and not necessarily strictly illustrated. In each of the diagrams, substantially the same structural components are assigned with the same reference signs, and there are instances where redundant descriptions are omitted or simplified.

### Embodiment

### Configuration of Learning Assistance Device

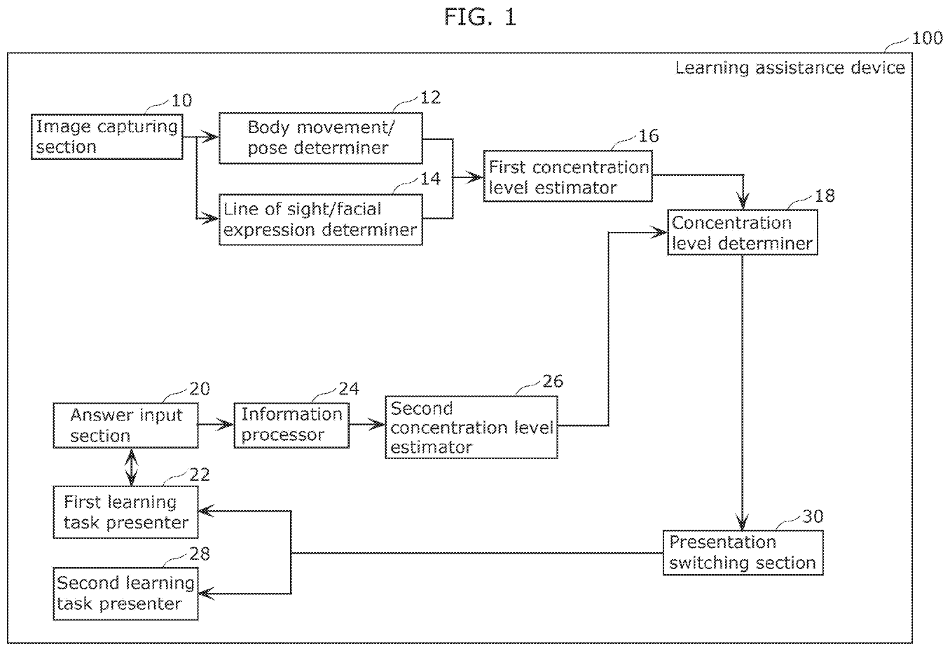

First, the configuration of learning assistance device 100 will be described. FIG. 1 is a block diagram illustrating learning assistance device 100 according to an embodiment. Learning assistance device 100 includes: image capturing section 10; body movement/pose determiner 12; line of sight/facial expression determiner 14, first concentration level estimator 16, concentration level determiner 18, answer input section 20, first learning task presenter 22, information processor 24, second concentration level estimator 26, second learning task presenter 28, and presentation switching section 30.

Image capturing section 10 captures an image of a face or a body of a user. Image capturing section 10 is implemented by a web camera or the like which is built into a personal computer, or a digital camera or the like that can be connected to a personal computer. In addition, image capturing section 10 has an eye tracking function. Alternatively, image capturing section 10 may be implemented by an infrared camera or the like. Image capturing section 10 transmits image data that has been obtained to body movement/pose determiner 12 and line of sight/facial expression determiner 14.

Body movement/pose determiner 12 recognizes a position for each of two or more portions of the body of the user in the image that has been obtained by image capturing section 10. In addition, body movement/pose determiner 12 is a processing device that calculates, based on the positions of the two or more portions of the body of the user that have been recognized, a target positional relationship which is the positional relationship of each of the two or more portions of the body of the user. Body movement/pose determiner 12 is implemented, for example, by a processor, a storage device, and a program stored in the storage device.

Body movement/pose determiner 12 identifies, by means of image recognition, the body of the user and the others on the image received from image capturing section 10. In addition, body movement/pose determiner 12 identifies, for each of the portions, the body of the user that has been identified, and recognizes the position on the image for each of the portions. In this manner, the target positional relationship which is the positional relationship between two or more portions of the body of the user on the image is calculated. Here, the positional relationship between two or more portions is indicated by the distance between the two or more portions. For example, when the two or more portions are “a portion of the face of the user” and “the hand of the user,” body movement/pose determiner 12 calculates the target positional relationship as, for example, “a portion of the face and the hand are within a specific distance”. Body movement/pose determiner 12 transmits the target positional relationship that has been calculated to first concentration level estimator 16.

A plurality of images are obtained, and the target positional relationship is calculated for each of the plurality of images. More specifically, the image obtained by image capturing section 10 is a video in which the images are consecutively lined up in chronological order. Accordingly, body movement/pose determiner 12 determines whether the user is in a state of concentration or not, in regard to an image for each of the frames included in the above-described video. In other words, with body movement/pose determiner 12, a numerical value sequence in which values each indicating either a state of concentration or a state of non-concentration that is not the state of concentration are consecutively aligned in chronological order is output based on the determination. The numerical value sequence corresponds to the video of the user whose image has been captured.

Line of sight/facial expression determiner 14 identifies the line of sight or facial expression of the user on the image received from image capturing section 10, by means of image recognition. Line of sight/facial expression determiner 14 obtains an image from a near-infrared light emitting diode (LED) and image capturing section 10, and performs arithmetic processing including image detection, a 3D eye model, and line of sight calculation algorithms. Line of sight/facial expression determiner 14 detects the line of sight of a user viewing a display or the like. More specifically, the near-infrared LED generates a reflection pattern of light on the cornea of the user, and image capturing section 10 obtains the reflection pattern. Then, line of sight/facial expression determiner 14 estimates the position and viewpoint of eyeballs in a space using image processing algorithms and a physiological 3D model of the eyeballs, based on the reflection pattern. It should be noted that line of sight/facial expression determiner 14 can also be configured using natural light illumination and a visible light color camera, and that the above-described configuration is mere one example.

In addition, line of sight/facial expression determiner 14 learns the face, etc. of the user through deep learning, etc., extracts a feature quantity of a face image of the user that has been captured, and determines the facial expression of the user based on the data that has been learnt and the feature quantity that has been extracted. Line of sight/facial expression determiner 14 is implemented, for example, by a processor, a storage device, and a program stored in the storage device. Line of sight/facial expression determiner 14 transmits the information related to the viewpoint of the user that has been estimated or the information related to the facial expression of the user that has been determined, to first concentration level estimator 16.

First concentration level estimator 16 is a processing device that determines whether the user is in a state of concentration, based on the target positional relationship and the facial expression of the user. First concentration level estimator 16 is implemented, for example, by a processor, a storage device, and a program stored in the storage device.

First concentration level estimator 16 estimates a first concentration level of the user based on the target positional relationship obtained from body movement/pose determiner 12. A habit of the user is known in advance by first concentration level estimator 16, and first concentration level estimator 16 determines whether the target positional relationship calculated by body movement/pose determiner 12 matches the habit of the user or not. When the target positional relationship matches the habit of the user, it is possible to determine that the user is taking an action that could be taken when the user is in a state of concentration. In other words, since the user is taking the above-described action, first concentration level estimator 16 can determine that the first concentration level of the user is high. Here, the first concentration level is the concentration level when the user performs a task that is passively performed (hereinafter referred to as a passive task). A passive task is, for example, video viewing, etc.

It should be noted that, in this Specification, a habit is an action that can be taken when a person is in a state of concentration, and is an action that can be estimated from the positional relationship (i.e., distance) between two or more portions of a person's body. Accordingly, a habit can be defined as a positional relationship between two or more portions of a body of a person, or a movement estimated from such a positional relationship.

First concentration level estimator 16 calculates, as the concentration level of user 1, the ratio of a time period in which the user was in the state of concentration to a total measured time period for a predetermined time range, using the target positional relationship output by body movement/pose determiner 12. For example, when the total time period in which user 1 was in the state of concentration was four minutes out of a 5-minute video, 4/5=0.8 is calculated as the concentration level. In addition, for example, first concentration level estimator 16 may calculate 0.8×100=80% as a concentration level, using a percentage.

First concentration level estimator 16 estimates the first concentration level of the user based on the information related to the viewpoint of the user that has been estimated by line of sight/facial expression determiner 14 or the information related to the facial expression of the user that has been determined. For example, first concentration level estimator 16 determines that the first concentration level of the user is high when there is little movement over time in the space of the viewpoint of the user that has been estimated by line of sight/facial expression determiner 14. In addition, for example, first concentration level estimator 16 may determine in advance the facial expression of the user when the concentration level of the user is high, and determine that the first concentration level of the user is high when line of sight/facial expression determiner 14 determines that the facial expression of the user is the expression described above. First concentration level estimator 16 outputs, to concentration level determiner 18, the first concentration level of the user that has been calculated.

Answer input section 20 is a terminal where the user inputs an answer or an interface such as a screen for inputting an answer that is presented to the user. The user inputs the answer to a problem presented by first learning task presenter 22 into answer input section 20. Answer input section 20 transmits the answer that has been obtained, to information processor 24. Answer input section 20 is implemented, for example, by a processor, a storage device, and a program stored in the storage device. Answer input section 20 may be provided with a display such as a touch panel display or a liquid crystal display, and input buttons or a keyboard.

First learning task presenter 22 is an interface such as a terminal or a screen that presents to the user a first learning task that the user actively learns. First learning task presenter 22 presents to the user the first learning task that the user actively learns, such as a problem for performing intellectual training such as a calculation problem, a problem related to knowledge of Kanji characters, a problem related to English vocabulary, etc. and that requires input of an answer from the user. The first learning task is also referred to as an active task. First learning task presenter 22 is implemented, for example, by a processor, a storage device, and a program stored in the storage device. Answer input section 20 may be provided with a display such as a touch panel display or a liquid crystal display. First learning task presenter 22 transmits, to answer input section 20, information about what kind of problem is presented by first learning task presenter 22. In addition, first learning task presenter 22 presents a problem based on a signal from presentation switching section 30.

Information processor 24 obtains the answer that has been input by the user from answer input section 20, and calculates indices related to the problem presented to the user, such as the right or wrong of the answer, the progress speed of the problem, the amount of processing of the problem, the answer score, and the correct answer rate. Information processor 24 is implemented, for example, by a processor, a storage device, and a program stored in the storage device.

Second concentration level estimator 26 obtains, from information processor 24, an index related to the problem presented to the user, and estimates the second concentration level of the user based on the index. Here, the second concentration level is the concentration level when the user performs a task that is actively performed (hereinafter referred to as an active task). An active task is, for example, answering a problem that has been given. For example, second concentration level estimator 26 estimates that the second concentration level of the user is high when the user's rate of correct answers to problems is high. Alternatively, for example, second concentration level estimator 26 may estimate that the second concentration level of the user is high when the user's progress speed on a problem is high. Second concentration level estimator 26 outputs, to concentration level determiner 18, the second concentration level of the user that has been calculated. Second concentration level estimator 26 is implemented, for example, by a processor, a storage device, and a program stored in the storage device.

Concentration level determiner 18 determines the concentration level of the user using the first concentration level or the second concentration level obtained from first concentration level estimator 16 or second concentration level estimator 26. More specifically, when learning assistance device 100 is presenting a problem to the user, concentration level determiner 18 obtains the first concentration level and the second concentration level from first concentration level estimator 16 and second concentration level estimator 26, and determines the concentration level of the user by normalizing and comparing the first concentration level and the second concentration level.

In addition, when learning assistance device 100 is presenting a video to the user, concentration level determiner 18 determines the concentration level of the user by comparing the first concentration level obtained from first concentration level estimator 16 with a first value. Concentration level determiner 18 outputs the information related to the concentration level of the user that has been determined, to presentation switching section 30. Concentration level determiner 18 is implemented, for example, by a processor, a storage device, and a program stored in the storage device.

Presentation switching section 30 switches between a video and a problem to be presented on a display, based on at least one of the first concentration level or the second concentration level. How to switch the content to be presented to the user is determined based on the information related to the concentration level of the user that has been obtained from concentration level determiner 18. For example, when learning assistance device 100 is presenting a video to the user, presentation switching section 30 determines that the content to be presented to the user is switched to a video which is lower in difficulty than the video currently being presented, when the first concentration level is higher than the second concentration level. Presentation switching section 30 is implemented, for example, by a processor, a storage device, and a program stored in the storage device. Presentation switching section 30 obtains signals from concentration level determiner 18 and transmits a signal related to switching the content to be presented to the user, to first learning task presenter 22 and second learning task presenter 28.

Second learning task presenter 28 is an interface such as a terminal or a screen that presents to the user a second learning task that the user passively learns. The second learning task is, for example, a video, etc. In addition, the second learning task is also referred to as a passive task. Second learning task presenter 28 is implemented, for example, by a processor, a storage device, and a program stored in the storage device. Second learning task presenter 28 may include a display such as a touch panel display or a liquid crystal display. Second learning task presenter 28 presents a video based on a signal from presentation switching section 30.

### Processing of Learning Assistance Device

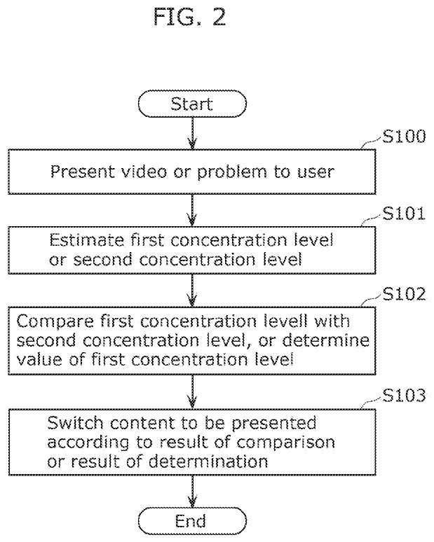

Next, the processing performed by learning assistance device 100 will be described. FIG. 2 is a flowchart illustrating the processing of learning assistance device 100 according to the embodiment.

First, learning assistance device 100 presents a video or a problem to the user (Step S100). Learning assistance device 100 presents the video on second learning task presenter 28 or the problem on first learning task presenter 22.

Next, learning assistance device 100 estimates the first concentration level or the second concentration level (Step S101). Learning assistance device 100 estimates the first concentration level using first concentration level estimator 16 or the second concentration level using second concentration level estimator 26.

Learning assistance device 100 then compares the first concentration level with the second concentration level, or determines the value of the first concentration level (Step S102). Learning assistance device 100 compares the magnitude relationship between the first concentration level and the second concentration level, or determines the magnitude relationship between the first concentration level and the first value, using concentration determination unit 18.

Learning assistance device 100 then switches content to be presented to the user according to the result of the comparison between the first concentration level and the second concentration level or the result of the determination of the value of the first concentration level (Step S103). Learning assistance device 100 determines, at presentation switching section 30, a switching method of how to switch the content to be presented to the user, and transmits the switching method that has been determined, to first learning task presenter 22 or second learning task presenter 28. The following describes in detail those described in FIG. 1 and FIG. 2.

### Active Task and Passive Task

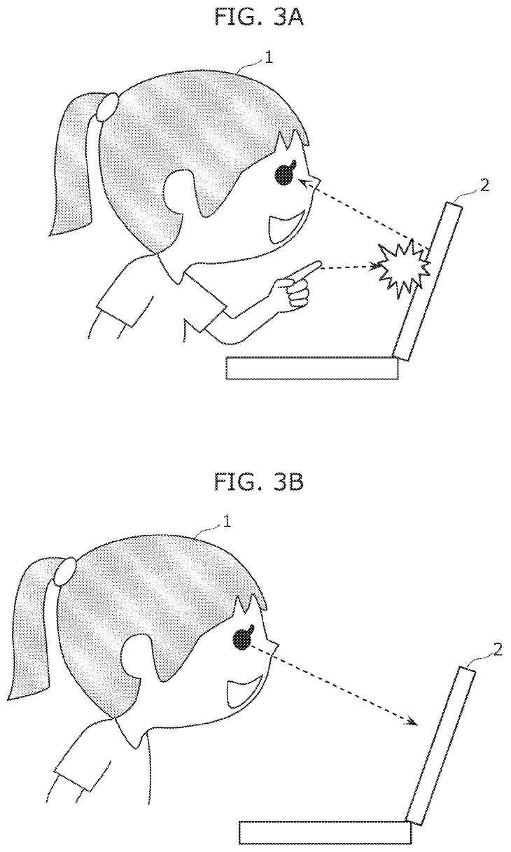

Next, an active task and a passive task presented by learning assistance device 100 will be described in detail. The active task and the passive task are videos or problems presented in Step S100 illustrated in FIG. 2. Here, the video (passive task) or the problem (active task) presented in Step S100 illustrated in FIG. 2 will be described. FIG. 3A is a diagram illustrating a situation in which user 1 is performing an active task. In addition, FIG. 3B is a diagram illustrating a situation in which user 1 is performing a passive task.

The active task illustrated in FIG. 3A refers to a task in which user 1 actively inputs an answer, etc. An active task is, specifically, a calculation problem, a problem related to Kanji characters, a problem related to English vocabularies, a problem that requires an answers involving other knowledge, a graphic problem, a problem to read and understand sentences, etc. The passive task illustrated in FIG. 3B refers to a task in which user 1 passively performs, for example, video viewing. A passive task specifically refers to viewing videos of math, Japanese, English, science, or social studies classes, viewing musical performances, viewing paintings or visual art works, viewing plays, viewing videos of educational content, etc.

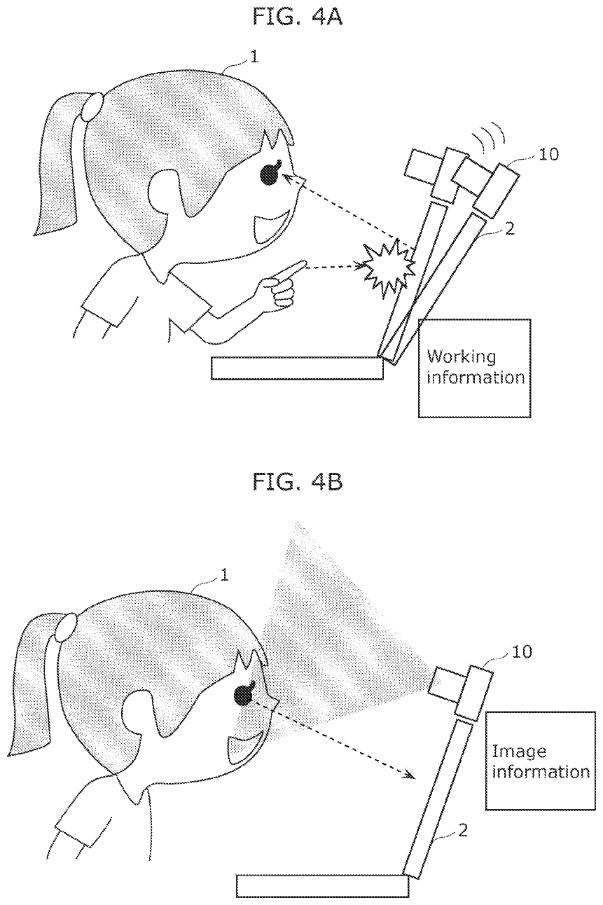

FIG. 4A is a diagram illustrating a situation in which the concentration level of user 1 during performing an active task is measured. When learning assistance device 100 presents an active task to user 1, user 1 views the problem displayed on display 2, etc., and inputs an answer into learning assistance device 100 through a keyboard or a touch panel, etc. Learning assistance device 100 estimates the second concentration level of user 1 from working information. Here, the working information includes a touch rate to the touch panel display when user 1 answers a problem, the rate of correct answers to problems, the response time to input an answer, the progress speed of a problem, the amount of processing of problems, the answer score, etc. It should be noted that user 1 may also input answers to the active task by voice through a microphone or the like.

In addition, learning assistance device 100 obtains an image of the face or body of user 1 from image capturing section 10 while the active task is presented to user 1. Learning assistance device 100 analyzes the image that has been obtained, and estimates the first concentration level of user 1. More specifically, learning assistance device 100 determines the facial expression of user 1, information related to the line of sight or viewpoint of user 1, a target positional relationship indicating the pose or the like of user 1, etc., and estimates the first concentration level.

FIG. 4B is a diagram illustrating a situation in which the concentration level of user 1 during performing a passive task is measured. When learning assistance device 100 presents a passive task to user 1, user 1 views a video displayed on display 2 or the like. Learning assistance device 100 analyzes the image obtained by image capturing section 10 to estimate the first concentration level of user 1 from the facial image of user 1, information related to the line of sight or viewpoint, a target positional relationship indicating the pose or the like of user 1, or a physiological indicator such as a body temperature, etc. Learning assistance device 100 may perform analysis with higher precision during performing a passive task than during performing an active task. It should be noted that learning assistance device 100 may obtain the physiological indicator of user 1, such as a pulse rate or a body temperature, from a wearable device or a smartphone.

### Estimation of First Concentration Level

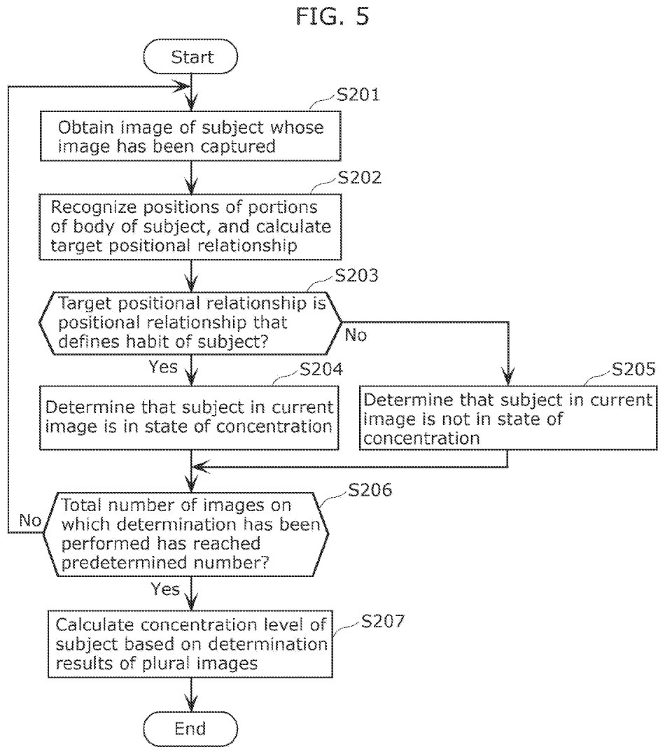

Next, the process of the estimation of the first concentration level performed by learning assistance device 100 will be described. FIG. 5 is a flowchart illustrating the processing of determining the first concentration level performed by learning assistance device 100 according to the embodiment. Here, the estimation of the first concentration level performed in Step S101 illustrated in FIG. 2 will be described.

Image capturing section 10 according to the present embodiment obtains an image of user 1 whose image has been captured, by receiving the image, thereby performing an obtaining step (S201). In addition, image capturing section 10 transmits, to body movement/pose determiner 12, the image that has been obtained.

Body movement/pose determiner 12 then identifies the body of user 1 and the other portions of user 1 by performing image recognition, for the image received from image capturing section 10, and further identifies the body of user 1 for each of the portions. Body movement/pose determiner 12 recognizes a position on the image for each of the portions of the body of user 1. Body movement/pose determiner 12 further performs a recognition step (S202) to calculate a target positional relationship which is a positional relationship for each of two or more portions among the portions of the body of user 1 on the image, from the positions that have been recognized.

First concentration level estimator 16 then performs a determining step to determine whether the above-described user 1 is in a state of concentration, based on the target positional relationship in the obtained image and the positional relationship of two or more portions of the body that defines a habit of user 1. First concentration level estimator 16 obtains, for example, the positional relationship of two or more portions of the body that defines the habit of user 1, using habit information of user 1 stored in the storage. First concentration level estimator 16 further determines whether the positional relationship corresponding to the habit of user 1 is not included in the target positional relationship that has been calculated from the image (S203), thereby determining whether user 1 is in a state of concentration.

For example, when the positional relationship corresponding to the habit of user 1 corresponds (i.e., matches or can be regard as equivalent) to the target positional relationship calculated from the image (Yes in S203), first concentration level estimator 16 determines that user 1 is in a state of concentration (S204). In addition, for example, when the positional relationship corresponding to the habit of user 1 does not correspond to the target positional relationship calculated from the image (No in S203), first concentration level estimator 16 determines that user 1 is not in the state of concentration (S205).

Next, first concentration level estimator 16 performs determines whether user 1 is in a state of concentration, for each frame of the image obtained by image capturing section 10. Here, learning assistance device 100 according to the present embodiment calculates the concentration level of user 1 in a predetermined time range. In other words, for a predetermined number of images (number of frames) corresponding to the predetermined time range, first concentration level estimator 16 determines whether user 1 is in the state of concentration.

First concentration level estimator 16 determines whether a total number of images on which determination has been performed has reached the predetermined number (S206), and when the predetermined number has not been reached (No in S206), the obtaining steps (S201) through Step S206 are repeated. In this manner, first concentration level estimator 16 obtains images and determines whether user 1 in the image is in the state of concentration, until the total number of images on which determination has been performed reaches the predetermined number.

When the total number of images on which determination has been performed reaches the predetermined number (Yes in S206), first concentration level estimator 16 performs a calculation step (S207) to calculate the concentration level of user 1, using the determination results of whether user 1 is in a state of concentration, which has been determined for the predetermined number of images. In this manner, learning assistance device 100 is capable of quantifying the degree to which user 1 was concentrating within a predetermined time range. First concentration level estimator 16 transmits the information related to the concentration level of user 1 to an outputter (not illustrated). In this manner, user 1 or an administrator or the like managing user 1 is capable of confirming the concentration level measured by learning assistance device 100.

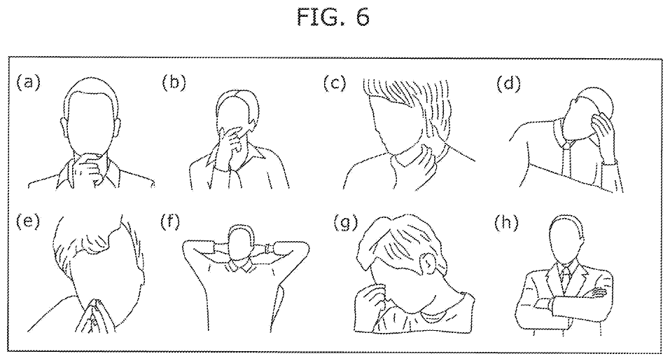

The following describes in more detail the determination of whether user 1 is in a state of concentration performed by first concentration level estimator 16, with reference to FIG. 6. FIG. 6 is a diagram illustrating an example of the habit of a subject that is used by learning assistance device 100 according to the embodiment in the determination of the first concentration level. In FIG. 6, (a) is a diagram illustrating an image of user 1 when user 1 is in a state of concentration. In FIG. 6, (d) is a diagram illustrating an image of user 1 when user 1 is not in a state of concentration. It should be noted here that the habit of user 1 during time of concentration is the action of touching the chin (i.e., a portion of the face) with the hand.

As illustrated in (a) in FIG. 6, a body part recognizer (not illustrated) recognizes, as coordinates on the image, the position of the chin that is one portion of the body and a hand that is another portion of the body of user 1 on the image. In addition, based on the action of touching the chin with the hand that is a habit of user 1 during time of concentration, a concentration habit determiner (not illustrated) determines whether the shortest distance between the chin and the hand is 0 or within a distance that can be considered equal to 0. In (a) in FIG. 6, the minimum distance of coordinates on the image corresponding to the chin and the hand of user 1 is 0. Therefore, user 1 in (a) of FIG. 6 is determined to be in a state of concentration in which the habit during time of concentration is indicated.

On the other hand, as illustrated in (d) in FIG. 6, body movement/pose determiner 12 recognizes, as coordinates on the image, the position of only the chin that is a portion of the body of user 1 on the image. Since the hand was not recognized in the image, the distance between the chin and the hand is not calculated, and the action of touching the chin with the hand that is the habit of user 1 is not indicated. As a result, user 1 in (d) in FIG. 6 is determined to be not in the state of concentration in which the habit during time of concentration is indicated.

### Estimation of Second Concentration Level

Next, the estimation of the second concentration level performed by learning assistance device 100 will be described. Here, the estimation of the second concentration level performed in Step S101 illustrated in FIG. 2 will be described. The second concentration level is represented as the ratio of the time during which user 1 was concentrating to the time during which the task was performed. The time during which user 1 was concentrating is calculated by multiplying the expectation of response time by the total number of responses. The response time is represented by a mixed normal distribution. Specifically, the response time is represented by the following Expressions (1) to (5).

$${f}_{l} ( t ) = \frac{1}{\sqrt{2 π} {σ}_{l} t} exp ( - \frac{{( ln ( t ) - {μ}_{l} )}^{2}}{2 {σ}_{l}^{2}} ) \cdot p t \qquad ( 1 )$$

$${f}_{h} ( t ) = \frac{1}{\sqrt{2 π} {σ}_{h} t} exp ( - \frac{{( ln ( t ) - {μ}_{h} )}^{2}}{2 {σ}_{h}^{2}} ) \cdot ( 1 - p ) t \qquad ( 2 )$$

$$f ( t ) = {f}_{l} ( t ) + {f}_{h} ( t ) \qquad ( 3 )$$

$$CT = exp ( {μ}_{l} + \frac{{σ}_{l}^{2}}{2} ) \cdot N \qquad ( 4 )$$

$$CTR = \frac{CT}{{T}_{total}} \qquad ( 5 )$$

In the expressions above, f(t) denotes the distribution of response times, fₗ and fₕ are lognormal distributions used for the mixed normal distribution, and fₗ is defined by μₗ and σₗ. In addition, fₕ is defined by μₕ and σₕ. The parameter p is the mixing coefficient. In addition, CT denotes the concentration time (the time during which user 1 was concentrating), and N denotes the total number of responses. In addition, CTR denotes the concentration time ratio (the ratio of the time during which user 1 was concentrating on the task to the time during which the task was performed), and Tₜₒₜₐₗ denotes the total task performing time (the total amount of time during which the target task was performed). It should be noted that here the second concentration level has been defined for the entire time during which the task was performed, but the second concentration level may be defined for a shorter time period (i.e., time slots). In that case, the second concentration level is also a value that indicates a temporal variation in the same manner as the first concentration level.

### Determination of the State of User 1

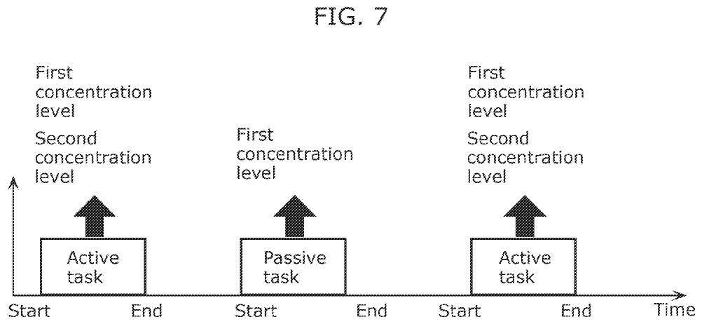

Next, determination of the state of user 1 performed by concentration level determiner 18 will be described. Here, the processing performed in Step S102 illustrated in FIG. 2 will be described. FIG. 7 is a diagram illustrating a time slot of the comparison between the first concentration level and the second concentration level performed by concentration level determiner 18 according to the embodiment.

Concentration level determiner 18 determines the state of user 1 by comparing the first concentration level and the second concentration level. In addition, concentration level determiner 18 performs the determination of the state of user 1 intermittently, rather than continuously. More specifically, concentration level determiner 18 calculates, for each time during which learning assistance device 100 performs one active task or one passive task, a mean value of the first concentration level or the second concentration level of user 1 estimated from data obtained during the time, and determines the state of user 1 during the time, using the mean value.

Alternatively, concentration level determiner 18 may estimate the first concentration level or the second concentration level of user 1 from the data obtained during the time that learning assistance device 100 is performing one active or one passive task, determine the concentration level of user 1 from the first concentration level or second concentration level which has been estimated, and use the mean value of a plurality of concentration levels of user 1 that have been determined during the time as a representative value of the concentration level of user 1 during the time. For example, concentration level determiner 18 compares the magnitude relationship between the first concentration level and the second concentration level, thereby determining the state of user 1.

In addition, concentration level determiner 18 may use a median value instead of a mean value when performing the above-described processing. The time during which learning assistance device 100 performs one active task or one passive task is specifically 30 minutes, for example.

In addition, the data indicating the first concentration level and the data indicating the second concentration level are normalized so that the first concentration level and the second concentration level can be compared. Any scheme may be used for the normalization.

For example, as illustrated in FIG. 7, learning assistance device 100 first performs the active task. The performing time is, for example, 30 minutes. Then, concentration level determiner 18 determines the state of user 1 during the performing time based on the representative value of the first concentration level and the representative value of the second concentration level that have been estimated during the performing time. Next, learning assistance device 100 performs the passive task. The performing time is, for example, 30 minutes. Then, concentration level determiner 18 determines the concentration level of user 1 during the performing time based on the representative value of the first concentration level that has been estimated during the performing time. Then, learning assistance device 100 performs the active task. The performing time is, for example, 30 minutes. Then, concentration level determiner 18 determines the state of user 1 during the performing time based on the representative value of the first concentration level and the representative value of the second concentration level that have been estimated during the performing time. As described above, concentration level determiner 18 determines the state of user 1 during a predetermined period based on the mean value of the first concentration level or the second concentration level during the predetermined period, instead of continuously and sequentially determining the concentration level of user 1. It should be noted that the predetermined period may be the entirety of the 30-minute performing time, or may be a short time period (time slot) such as 1 minute or 3 minutes.

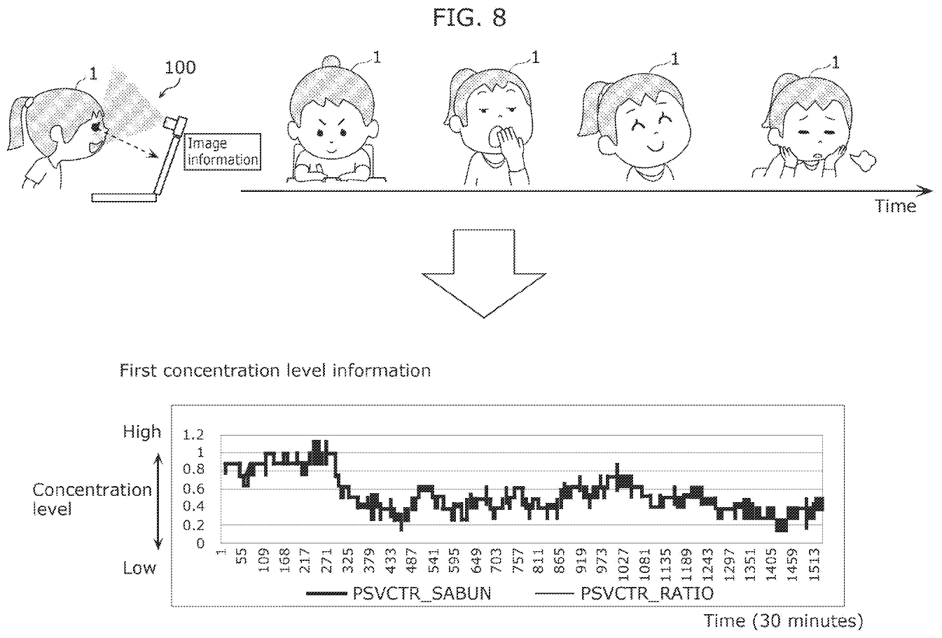

Next, the measurement of the concentration level performed by learning assistance device 100 will be described in detail. FIG. 8 is a diagram illustrating an overview of the measurement of the first concentration level in learning assistance device 100 according to the embodiment.

First, the case where user 1 is performing video viewing (passive task) will be considered. The time for user 1 to perform the video viewing is, for example, 30 minutes. While user 1 is performing the video viewing, learning assistance device 100 obtains image data of user 1 from image capturing section 10. The image obtained from image capturing section 10 is analyzed by body movement/pose determiner 12 and line of sight/facial expression determiner 14.

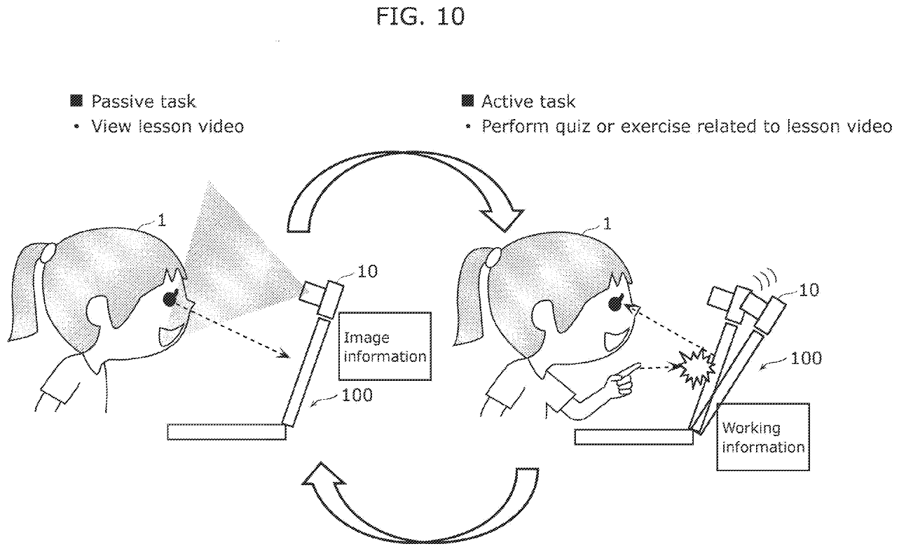

For example, as a result of the analysis of body movement/pose determiner 12 and line of sight/facial expression determiner 14, a pose of user 1 taking notes with a serious expression is confirmed immediately after user 1 starts the video viewing, in the example illustrated in FIG. 10. Next, a pose of user 1 yawning is confirmed. Then, it is confirmed that user 1 is having a cheerful expression, and finally confirmed that that user 1 is having a tired expression with her chin resting on her hands.

FIG. 8 illustrates a graph indicating a result of the estimation of the concentration level of user 1 performed by first concentration level estimator 16 based on these poses and facial expressions. For example, the first concentration level is estimated to be relatively high during the time period when a pose of user 1 taking notes with a serious expression is confirmed, and the first concentration level is estimated to be relatively low during the time period when a pose of user 1 yawning is confirmed. In addition, the first concentration level is estimated to be higher during the time period when it is confirmed that user 1 is having a cheerful expression than during the immediately preceding time period, and finally, the first concentration level is estimated to be relatively low during the time period when it is confirmed that user 1 is having a tired expression with her chin resting on her hands.

Concentration level determiner 18 determines the state of user 1, based on the representative value which is the mean value of the first concentration level over 30 minutes, etc., as indicated above.

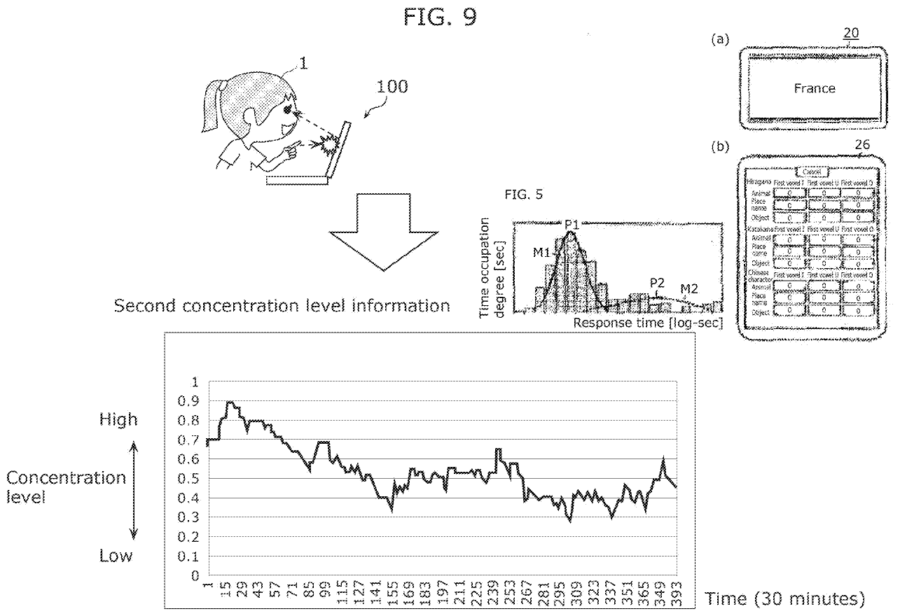

FIG. 9 is a diagram illustrating an overview of the measurement of the second concentration level in learning assistance device 100 according to the embodiment. Next, the case where user 1 is answering a problem (active task) will be considered. The time period for user 1 to answer a problem is assumed to be, for example, 30 minutes. While user 1 is answering a problem, learning assistance device 100 obtains image data of user 1 from image capturing section 10. The image obtained by image capturing section 10 is analyzed by body movement/pose determiner 12 and line of sight/facial expression determiner 14. In addition, information processor 24 obtains, as the working information, a touch rate to the touch panel display when user 1 answers a problem, the rate of correct answers to the problems, the response time to input the answer, the progress speed of the problem, the amount of processing of the problem, the answer score, etc. Then, second concentration level estimator 26 estimates the second concentration level of user 1 based on the working information.

For example, second concentration level estimator 26 estimates that the second concentration level is high when the rate of correct answers to problems is high. Alternatively, second concentration level estimator 26 may estimate that the second concentration level is high when the response time to input the answer is short. As illustrated in FIG. 9, the second concentration level is successively estimated during 30 minutes in which the active task is presented by learning assistance device 100.

Concentration level determiner 18 determines the state of user 1, based on the representative value which is the mean value of the first concentration level over 30 minutes, etc., as indicated above.

### Switching of Active Task and Passive Task

Next, switching of the active task and the passive task according to the state of user 1 performed by learning assistance device 100 will be described. Here, the processing performed in Step S103 illustrated in FIG. 2 will be described in detail. FIG. 10 is a diagram illustrating the switching of the active task and the passive task in learning assistance device 100 according to the embodiment. As illustrated in FIG. 10, learning assistance device 100 switches between a passive task of viewing a lesson video and an active task of performing a quiz or exercise related to the lesson video, depending on the state of user 1. It should be noted that learning assistance device 100 may switch from one passive task to another passive task that is different in the level of difficulty from the one passive task, or from one active task to another active task that is different in the level of difficulty from the one active task, depending on the state of user 1.

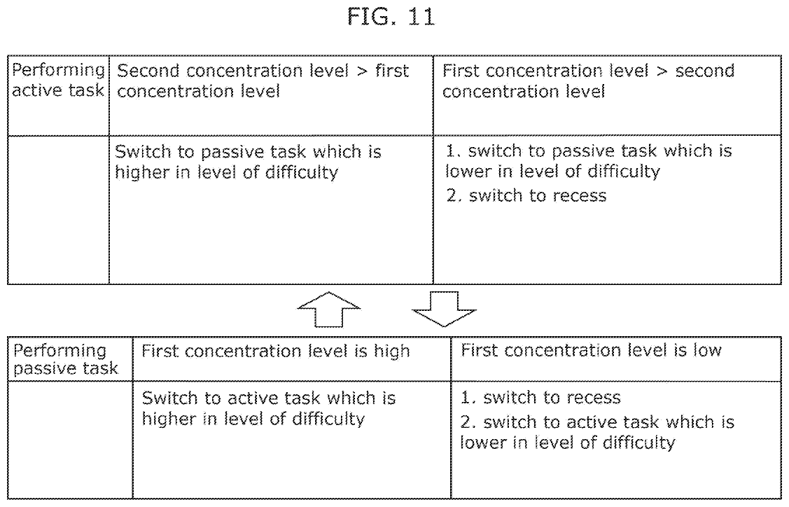

FIG. 11 is a table illustrating the details of the switching between the active task and the passive task in learning assistance device 100 according to the embodiment. When learning assistance device 100 is presenting an active task and the second concentration level is higher than the first concentration level, it is determined that the level of the difficulty of the active task is too low for user 1. This is because, although the work performance of user 1 such as the rate of correct answers to the problems is high, it is not shown on the apparent facial expression of user 1. For user 1, learning and understanding of this assignment is considered to have been sufficiently accomplished. In view of the above, presentation switching section 30 switches content to be presented to a passive task which is higher in the level of difficulty. This means that learning assistance device 100 introduces user 1 to a lesson video or the like in the next stage of learning which is one level higher.

In addition, when learning assistance device 100 is presenting an active task and the first concentration level is higher than the second concentration level, it is determined that the level of the difficulty of the active task is too high for user 1. This is because the actual work performance such as the rate of correct answers to the problems is low, despite the fact that the apparent facial expression of user 1 suggests that user 1 is sufficiently concentrating. Alternatively, learning assistance device 100 determines that user 1 is in a so-called absentminded state (i.e., mind wandering state). In view of the above, presentation switching section 30 switches the content to be presented to a passive task which is low in the level of difficulty. This means, for example, that the assignment is switched back to one previous lesson video, and user 1 is allowed to review it again. In addition, in this case, presentation switching section 30 may switch the content to be presented to a recess. When learning assistance device 100 is presenting an active task and the first concentration level is higher than the second concentration level, whether presentation switching section 30 switches the content to be presented to a passive task which is low in the level of difficulty or to a recess is determined based on whether the first concentration level or the second concentration level is higher than a third value.

In addition, when learning assistance device 100 is presenting an active task, presentation switching section 30 may switch the active task to a passive task that is different in the level of difficulty according to the level of the second concentration level. For example, when learning assistance device 100 is presenting an active task and the second concentration level is higher than the first predetermined value, presentation switching section 30 may switch the content to be presented to a passive task which is high in difficulty. On the other hand, for example, when learning assistance device 100 is presenting an active task and the second concentration level is lower than a second predetermined value, presentation switching section 30 may switch the content to be presented to a passive task which is low in difficulty.

In addition, when learning assistance device 100 is presenting a passive task and the first concentration level is higher than the first value, presentation switching section 30 determines that user 1 is viewing the lesson video, etc. with sufficient concentration and switches the content to be presented to an active task which is higher in the level of difficulty as the next stage. On the other hand, when learning assistance device 100 is presenting a passive task and the first concentration level is lower than the second value, presentation switching section 30 may determine that user 1 is not concentrating on the lesson video and switch the content to be presented to a recess, or switch the content to be presented to an active task that prompts user 1 to answer a problem which is relatively low in the level of difficulty. It should be noted here that the second value is assumed to be smaller than the first value. When learning assistance device 100 is presenting a passive task and the first concentration level is lower than the first value, presentation switching section 30 determines whether to switch the content to be presented to a recess or to switch the content to be presented to an active task which is low in the level of difficulty, based on whether the first concentration level is higher than the third value.

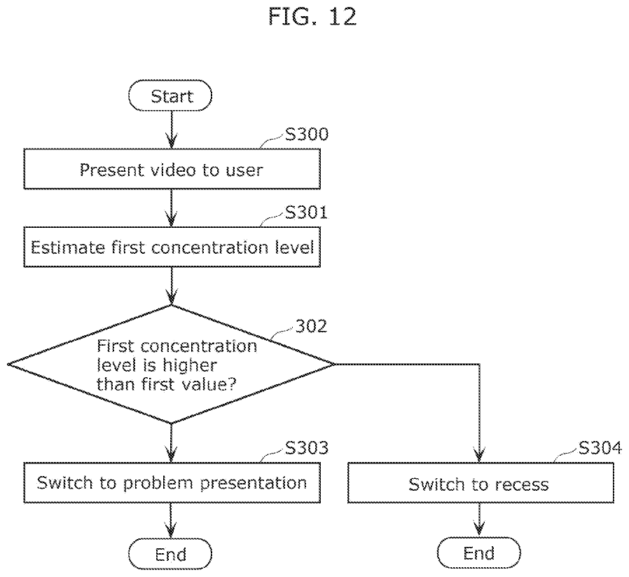

Next, an overview of the processing of switching of an active task and a passive task performed by learning assistance device 100 will be described. FIG. 12 is a flowchart illustrating an example of the processing performed by learning assistance device 100 according to the embodiment. The following describes, with reference to FIG. 12, the processing of switching of an active task and a passive task based on the concentration level of user 1 when learning assistance device 100 is presenting a passive task to user 1. The process illustrated in FIG. 12 is a specific example of the process illustrated in FIG. 2.

First, second learning task presenter 28 presents a video to user 1 (Step S300).

Next, first concentration level estimator 16 estimates the first concentration level of user 1 (Step S301).

Next, concentration level determiner 18 determines whether the first concentration level is higher than the first value (Step S302).

When concentration level determiner 18 determines that the first concentration level is higher than the first value (Yes in Step S302), presentation switching section 30 switches the content to be presented to problem presentation (Step S303). More specifically, presentation switching section 30 causes second learning task presenter 28 to stop outputting the video and causes first learning task presenter 22 to output a problem. Here, presentation switching section 30 causes first learning task presenter 22 to output a problem which is high in the level of difficulty.

When concentration level determiner 18 determines that the first concentration level is lower than the first value (No in Step S302), presentation switching section 30 switches the content to be presented to a recess (Step S304). More specifically, presentation switching section 30 causes second learning task presenter 28 to stop outputting the video and causes first learning task presenter 22 to output content to prompt user 1 to take a recess. In addition, when concentration level determiner 18 determines that the first concentration level is lower than the first value and higher than the second value, presentation switching section 30 causes first learning task presenter 22 to output a problem which is low in the level of difficulty instead of the content to prompt user 1 to take a recess.

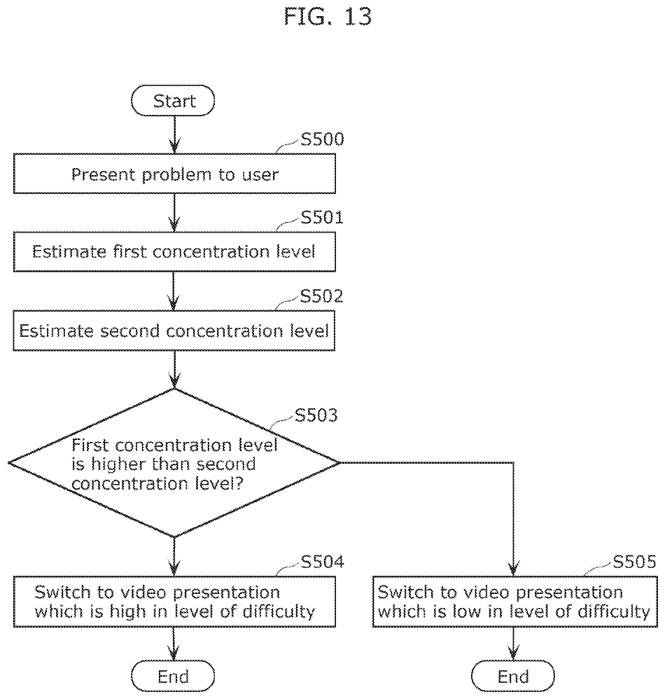

FIG. 13 is a flowchart illustrating another example of the processing performed by learning assistance device 100 according to the embodiment. The following describes, with reference to FIG. 13, the process of switching of an active task and a passive task based on the concentration level of user 1 when learning assistance device 100 is presenting an active task to user 1. The processing illustrated in FIG. 13 is a specific example of the processing illustrated in FIG. 2.

First, first learning task presenter 22 presents a problem to user 1 (Step S500).

Next, first concentration level estimator 16 estimates the first concentration level of user 1 (Step S501).

Next, second concentration level estimator 26 estimates the second concentration level of user 1 (Step S502). It should be noted that Step S501 and Step S502 may be in reverse order.

Concentration level determiner 18 then determines whether the second concentration level is higher than the first concentration level (Step S503).

When concentration level determiner 18 determines that the second concentration level is higher than the first concentration level (Yes in Step S503), presentation switching section 30 switches the content to be presented to a video which is high in the level of difficulty (Step S504). More specifically, presentation switching section 30 causes first learning task presenter 22 to stop outputting the problem and causes second learning task presenter 28 to output a video which is high in the level of difficulty.

When concentration level determiner 18 determines that the second concentration level is lower than the first concentration level (No in Step S503), presentation switching section 30 switches the content to be presented to a video which is low in the level of difficulty (Step S505). More specifically, presentation switching section 30 causes first learning task presenter 22 to stop outputting the problem and causes second learning task presenter 28 to output a video which is low in the level of difficulty. In addition, when concentration level determiner 18 determines that the second concentration level is lower than the first concentration level (No in Step S503), presentation switching section 30 may switch the content to be presented to a recess. Depending on whether the first concentration level or the second concentration level is higher than the third value, second learning task presenter 28 may switch between outputting a video which is low in the level of difficulty and outputting content that prompts user 1 to take a recess.

### Specific Examples of Concentration Level Determination and Switching Tasks

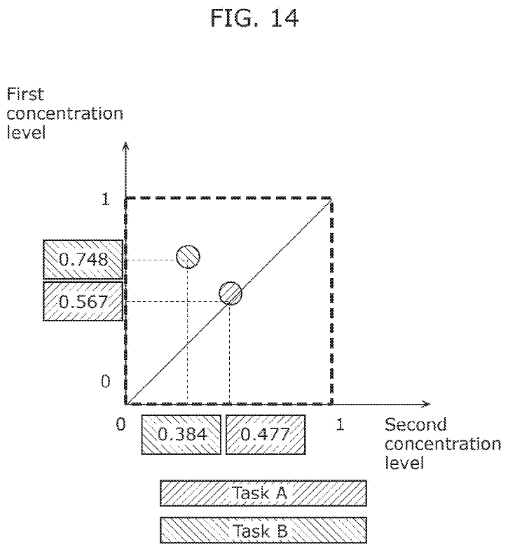

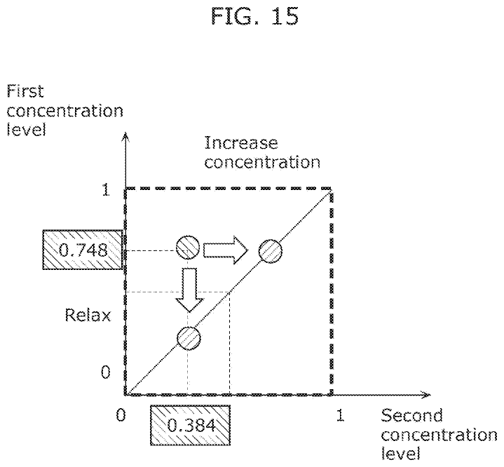

Next, determination of the concentration level of user 1 performed by learning assistance device 100 and switching tasks to be presented to user 1 by learning assistance device 100 will be described in detail. FIG. 14 is a diagram illustrating an example of determination of the state of user 1 by comparing the first concentration level and the second concentration level in learning assistance device 100 according to the embodiment. In addition, FIG. 15 is a diagram illustrating an example of guidance of the state of user 1 by comparing the first concentration level and the second concentration level in learning assistance device 100 according to the embodiment.

FIG. 14 illustrates a graph plotting the concentration level of user 1 when an active task is presented to user 1 by learning assistance device 100, with the first concentration level being on the vertical axis and the second concentration level being on the horizontal axis. More specifically, task A is plotted at a point at which the first concentration level is 0.567 and the second concentration level is 0.477. In addition, task B is plotted at a point at which the first concentration level is 0.748 and the second concentration level is 0.384. Concentration level determiner 18 interprets that in task A, the first concentration level and the second concentration level are almost equal, and that the work attitude of user 1 and performance are balanced. In the state of task A, presentation switching section 30 switches the content to be presented to a passive task that is low in the level of difficulty.

In addition, concentration level determiner 18 interprets that in task B, the first concentration level is higher than the second concentration level, and that the work attitude of user 1 is fine but the performance is decreased. In other words, concentration level determiner 18 determines that user 1 is in an absentminded state in task B. In the state of task B, presentation switching section 30 switches the content to be presented to a recess. At this time, learning assistance device 100 presents a video or music to user 1 that has an effect of relaxing user 1.

In addition, in the state of task B, presentation switching section 30 may switch the content to be presented to an active task which is low in the level of difficulty than the currently presented active task. Alternatively, in the state of task B, presentation switching section 30 may switch the content to be presented to a passive task. The passive task present at this time is, for example, a video, etc. for reviewing the active task performed immediately before.

By switching tasks as described above, learning assistance device 100 is capable of guiding user 1 to a state in which the concentration level and the second concentration level of user 1 are balanced, by either decreasing the first concentration level of user 1 when task B is performed or increasing the second concentration level of user 1 when task B is performed, as illustrated in FIG. 15. As a result, learning assistance device 100 is capable of guiding user 1 to a more concentrated state, by switching tasks as described above.

### Advantageous Effects, Etc

Learning assistance device 100 according to the present embodiment is a learning assistance device for user 1 to perform a learning task. Learning assistance device 1 includes: first concentration level estimator 16 that estimates a first concentration level of user 1, by analyzing information from image capturing section 10 that captures an image of user 1; second concentration level estimator 26 that estimates a second concentration level of user, by analyzing information which user 1 has actively input when performing a learning task; and switching section 30 that switches between learning task content and between presentation schemes, based on at least one of the first concentration level or the second concentration level.

According to the above-described configuration, learning assistance device 100 is capable of presenting an appropriate one of the first learning task that is actively learnt by user 1 and the second learning task that is passively learnt by user 1, according to the state of user 1 that is estimated from the concentration level of user 1.

In addition, for example, learning assistance device 100 further includes first learning task presenter 22 that presents a first learning task to user 1, the first learning task being actively learnt by user 1. In learning assistance device 100, while the first learning task is presented to user 1 by first task presenter 22, switching section 30 switches content to be presented to user 1 to the first learning task with a level of difficulty that differs according to a magnitude relationship between the first concentration level and the second concentration level.

According to the above-described configuration, when presenting the first learning task to user 1, learning assistance device 100 is capable of switching presentation to the second learning task with an appropriate level of difficulty, according to the state of user 1 that is estimated from the concentration level of user 1.

In addition, for example, in learning assistance device 100, while the first learning task is presented to user 1 by first learning task presenter 22, switching section 30 switches content to be presented to user 1 to a second learning task with a level of difficulty that differs according to the second concentration level, the second learning task being passively learnt by user 1.

According to the above-described configuration, when presenting the first learning task to user 1, learning assistance device 100 is capable of switching presentation to the second learning task with an appropriate level of difficulty, according to the state of user 1 that is estimated from the concentration level of user 1.

In addition, for example, learning assistance device 100 further includes second learning task presenter 28 that presents the second learning task to user 1. In learning assistance device 100, when the first concentration level is higher than a first value while the second learning task is presented to user 1 by second learning task presenter 28, switching section 30 switches content to be presented to user 1 to the first learning task.

According to the above-described configuration, when presenting the second learning task to user 1, learning assistance device 100 is capable of switching presentation to the first learning task with an appropriate level of difficulty, according to the state of user 1 that is estimated from the concentration level of user 1.

In addition, for example, learning assistance device 100 further includes concentration level determiner 18 that determines that user 1 is in an absentminded state when the first concentration level is higher than the second concentration level while the first learning task is presented to user 1 by first learning task presenter 22, and prompts user 1 to take a recess.

According to the above-described configuration, when presenting the first learning task to user 1, learning assistance device 100 is capable of prompting user 1 to take a recess, according to the state of user 1 that is estimated from the concentration level of user 1. As a result, it is possible to enhance the work efficiency of user 1.

In addition, for example, in learning assistance device 100, when the first concentration level is lower than a second value while the second learning task is presented to user 1 by second learning task presenter 28, concentration level determiner 18 prompts user 1 to take a recess.

According to the above-described configuration, when presenting the second learning task to user 1, learning assistance device 100 is capable of prompting user 1 to take a recess, according to the state of user 1 that is estimated from the concentration level of user 1. As a result, it is possible to enhance the work efficiency of user 1.

In addition, a learning assistance system according to the present disclosure is a learning assistance system for user 1 to perform a learning task. The learning assistance system includes: display 2; image capturing section 10 that captures an image of user 1; first concentration level estimator 16 that estimates a first concentration level of user 1, by analyzing information from image capturing section 10; second concentration level estimator 26 that estimates a second concentration level of user 1, by analyzing information which user 1 has actively input when performing the learning task; and presentation switching section 30 that switches between learning task content and between presentation schemes, based on at least one of the first concentration level or the second concentration level.

According to the above-described configuration, the learning assistance system according to the present disclosure is capable of yielding an advantageous effect equivalent to the advantageous effect yielded by the above-described learning assistance device 100.

### Others

Although the embodiment has been described thus far, the present disclosure is not limited to the above-described embodiment.

For example, in the above-described embodiment, processing performed by a specific processing unit may be performed by a different processing unit. Furthermore, the order of a plurality of processes may be rearranged. Alternatively, the plurality of processes may be performed in parallel.

In addition, for example, according to the foregoing embodiment, a learning assistance method for user 1 to perform a learning task may be performed. The learning assistance method including: estimating a first concentration level of user 1, by analyzing information from image capturing section 10 that captures an image of user 1; estimating a second concentration level of user, by analyzing information which user 1 has actively input when performing a learning task; and switching between learning task content and between presentation schemes, based on at least one of the first concentration level or the second concentration level.

In addition, each of the structural components in the above-described embodiment may be realized by executing a software program suitable for the structural components. Each of the structural components may be realized by means of a program executing unit, such as a CPU and a processor, reading and executing the software program recorded on a recording medium such as a hard disk or a semiconductor memory.

In addition, each of the structural components may be realized by hardware. For example, each of the structural components may be a circuitry (or an integrated circuit). The circuitries may be configured as a single circuitry as a whole or may be mutually different circuitries. In addition, the circuitries may each be a general-purpose circuit, or may be a dedicated circuit.

In addition, the generic or specific aspects of the present disclosure may be realized by a system, a device, a method, an integrated circuit, a computer program, or a computer-readable recording medium such as a compact disc read only memory (CD-ROM). Alternatively, the generic or specific aspects of the present disclosure may be implemented by any combination of systems, devices, methods, integrated circuits, computer programs, and recording medium.

For example, the present disclosure may be implemented as a program for causing a computer to execute the learning assistance method according to the foregoing embodiment. The present disclosure may be implemented as a non-transitory computer-readable recording medium on which the above-described program is stored.

Moreover, embodiments obtained through various modifications to the respective embodiments which may be conceived by a person skilled in the art as well as embodiments realized by arbitrarily combining the structural components and functions of the respective embodiments without materially departing from the spirit of the present disclosure are included in the present disclosure.

### INDUSTRIAL APPLICABILITY

The learning assistance device and the learning assistance system according to the present disclosure are capable of providing a user with an effective learning experience.

1. A learning assistance device for a user to perform a learning task, the learning assistance device comprising:
a first concentration level estimator that estimates a first concentration level of the user, by analyzing information from an image capturing section that captures an image of a user;
a second concentration level estimator that estimates a second concentration level of the user, by analyzing information which the user has actively input when performing the learning task; and
a presentation switching section that switches between learning task content and between presentation schemes, based on at least one of the first concentration level or the second concentration level.

2. The learning assistance device according to claim 1, further comprising:
a first learning task presenter that presents a first learning task to the user, the first learning task being actively learnt by the user, wherein
while the first learning task is presented to the user by the first learning task presenter,
the presentation switching section switches content to be presented to the user to the first learning task with a level of difficulty that differs according to a magnitude relationship between the first concentration level and the second concentration level.

3. The learning assistance device according to claim 1, wherein
while a first learning task is presented to the user by the first learning task presenter,
the presentation switching section switches content to be presented to the user to a second learning task with a level of difficulty that differs according to the second concentration level, the second learning task being passively learnt by the user.

4. The learning assistance device according to claim 1, further comprising:
a second learning task presenter that presents a second learning task to the user, wherein
when the first concentration level is higher than a first value while the second learning task is presented to the user by the second learning task presenter,
the presentation switching section switches content to be presented to the user to the first learning task.

5. The learning assistance device according to claim 1, further comprising:
a concentration level determiner that determines that the user is in an absentminded state when the first concentration level is higher than the second concentration level while a first learning task is presented to the user by the first learning task presenter, and prompts the user to take a recess.

6. The learning assistance device according to claim 5, wherein
when the first concentration level is lower than a second value while a second learning task is presented to the user by a second learning task presenter,
the concentration level determiner prompts the user to take a recess.

7. A learning assistance system for a user to perform a learning task, the learning assistance system comprising:
a display;
an image capturing section that captures an image of a user;
a first concentration level estimator that estimates a first concentration level of the user, by analyzing information from the image capturing section;
a second concentration level estimator that estimates a second concentration level of the user, by analyzing information which the user has actively input when performing the learning task; and
a presentation switching section that switches between learning task content and between presentation schemes, based on at least one of the first concentration level or the second concentration level.
